(19) United States
(12) Patent Application Publication
(10) Pub. No.: US 2012/0030920 A1
(43) Pub. Date: Feb. 9, 2012

(54) METHOD FOR PRODUCING A MAGNETIC SYSTEM COMPRISING A POLE WHEEL

(76) Inventors: Detlef Lange, Oberhausen (DE); Dieter Rupprich, Ohne (DE); Klaus Bodenstein, Hong Kong S.A.R. (CN)

(21) Appl. No.: 13/146,010

(22) PCT Filed: Nov. 19, 2009
(86) PCT No.: PCT/EP09/65459

§ 371 Date: Oct. 28, 2011

(30) Foreign Application Priority Data
Jan. 23, 2009 (DE) 10 2009 005 957.1

(51) Int. Cl. B23P 11/00

(52) U.S. Cl. 29/428

(57) ABSTRACT

In the case of a method for production of a magnet system (1), which comprises a pole wheel (13), of a multipole generator for a wind power installation or wind energy installation, comprising the connection of a pole wheel housing (11) to at least one magnet ring (2), which has a multiplicity of individual permanent magnets (4, 4′) arranged in the form of a circular ring, or to a magnet wheel (10) which has at least one magnet ring (2) and a support (5) supporting it, by heating of the pole wheel housing (11) to a temperature at which the internal diameter of an internal circumferential surface, which forms a retaining surface (14), of the pole wheel housing (11) expands to a size which is larger than the external diameter of the magnet ring (2) or of the magnet wheel (10), the arrangement of the at least one magnet ring (2) or of the magnet wheel (10) in or on the retaining surface (14), and the shrinking of the pole wheel housing (11) onto the at least one magnet ring (2) or the magnet wheel (10) by cooling down the pole wheel housing (11) to room temperature or ambient temperature, the aim is to provide a solution which provides a reliable and high-strength connection between a magnet ring or a magnet wheel and a pole wheel housing, with simple and cost-effective assembly at the same time. This is achieved in that, before the heating of the pole wheel housing (11) and/or before the arrangement of the magnet ring (2) or of the magnet wheel (10), and/or before the cooling down of the pole wheel housing (11), the external circumferential surface of the at least one magnet ring (2) or magnet wheel (10) and/or the retaining surface (14) is provided with an adhesive (15) such that an integral connection is formed between the pole wheel housing (11) and the at least one magnet ring (2) or magnet wheel (10) from the adhesive (15), while the pole wheel housing (11) is being shrunk on.

The invention relates to a method for production of a magnet system, which comprises a pole wheel, of a multipole generator for a wind power installation or wind energy installation, comprising the connection of a pole wheel housing to at least one magnet ring, which has a multiplicity of individual permanent magnets arranged in the form of a circular ring, or to a magnet wheel which has at least one magnet ring and a support supporting it, by heating of the pole wheel housing to a temperature at which the internal diameter of an internal circumferential surface, which forms a retaining surface, of the pole wheel housing expands to a size which is larger than the external diameter of the magnet ring or of the magnet wheel, the arrangement of the at least one magnet ring or of the magnet wheel in or on the retaining surface, and the shrinking of the pole wheel housing onto the at least one magnet ring or the magnet wheel by cooling down the pole wheel housing to room temperature or ambient temperature. The invention also relates to a magnet system of a multipole generator of a wind power installation or of a wind energy installation, comprising a pole wheel which has a pole wheel housing and has at least one magnet ring, which is arranged in the pole wheel housing and is formed from a support with individual permanent magnets arranged on it, and/or has a magnet wheel which has a magnet ring such as this.

An annular magnet system of a rotor of a multipole generator in the form of an external rotor is normally not constructed in a solid form, in order to reduce eddy-current losses, but comprises individual insulated laminate rings or magnet rings fitted with individual permanent magnets. These magnet rings are stacked to form a core, in the form of a magnet wheel corresponding to the axial overall length of the generator. In this case, a support which comprises individual laminate segments or metal segments forms a thin-walled magnetic return-path ring which is used for the magnetic lines of force to pass through and to provide external magnetic screening for the core. In this case, a core such as this obtains its mechanical strength in the axial direction in that holders or struts are welded into magnetically unloaded zones, and the individual magnet rings or the supports are held together in this way.

The production of a support and of a magnet ring for an external rotor is subject to manufacturing and financial restrictions relating to the relatively large diameter of a pole wheel of a generator of a wind energy installation, as a result of which, for large diameters, each individual annular support is composed of individual metal segments which have individual magnet segments, which are joined together to form a ring, on the inside of the support, thus forming a magnet ring. The magnet ring, which is formed from a plurality of magnet segments and a plurality of metal segments, is normally fitted in a pole wheel housing by means of a clamped connection between the individual segments which each rest on one another, in the form of an arch. For this purpose, the pole wheel housing is heated, as a result of which it widens and at least one magnet ring or a magnet wheel comprising a plurality of magnet rings can easily be inserted into the pole wheel housing. When the pole wheel housing is subsequently cooled down, this results in a clamped connection between the pole wheel housing and the magnet ring or the magnet wheel, in which the individual metal segments and/or the individual magnet segments are held together by the compressive stress which is created between each of the segments. This results in the pole wheel housing and the magnet ring or the magnet wheel being connected to one another in the form of a shrink connection, forming a magnet system for the rotor or the generator.

In this case, the connection mentioned above must be able to transmit to a stator of the generator the torques which are produced by the rotor blades of the wind energy installation and are transmitted to the pole wheel housing. However, with the diameter sizes of the pole wheels, and therefore of the magnet rings and magnet wheels as well, that are used nowadays, the joint pressure which exists between the individual metal segments and/or the individual magnet segments in the clamping joint or shrink joint is no longer sufficiently high to ensure the mechanical robustness of the annular shape of the support, which comprises metal segments in the form of circle sections, and the annular shape, which is composed of individual permanent magnets, on its internal circumferential surface, because the wall thickness of the support and the magnet ring has become relatively small in comparison to the diameter of the magnet ring, because of the large numbers of poles.

The invention is based on the object of providing a solution which provides a reliable and high-strength connection between a magnet ring or a magnet wheel and a pole wheel housing of a pole wheel of a multipole generator for a wind power installation or wind energy installation, with simple and cost-effective assembly at the same time.

In the case of a method of the type mentioned initially, this object is achieved according to the invention in that before the heating of the pole wheel housing and/or before the arrangement of the magnet ring or of the magnet wheel, and/or before the cooling down of the pole wheel housing, the external circumferential surface of the at least one magnet ring or magnet wheel and/or the retaining surface is provided with an adhesive such that an integral connection is formed between the pole wheel housing and the at least one magnet ring or magnet wheel from the adhesive, while the pole wheel housing is being shrunk on.

The abovementioned object is likewise achieved according to the invention in the case of a magnet system of the type mentioned initially in that the pole wheel has an integral connection between its pole wheel housing and the at least one magnet ring or the magnet wheel, with the magnet system being produced by means of a method according to one of claims 1 to 6.

Advantageous and expedient refinements and developments of the invention are specified in the respective dependent claims.

The invention provides a cost-effective method for production of a pole wheel and therefore of a magnet system, which comprises a pole wheel, of a multipole generator for a wind energy installation or wind power installation, which forms a reliable and high-strength connection between a pole wheel housing and a magnet ring or a magnet wheel. With respect to their diameter, it is therefore possible to produce even thin-walled magnet rings or magnet wheels for large generators with outputs in the Megawatt range and rotor housing diameters and pole wheel housing diameters of several metres, for example 10 m, because the robustness of the connection between the pole wheel housing and a magnet ring or a magnet wheel is now no longer based solely on the clamping force of the individual metal segments and magnet segments, but, in addition to this force-fitting connection, an integral connection is provided between the pole wheel housing and the magnet ring or the magnet wheel, which increases the load capability and the life of the connection of the pole wheel housing and magnet ring or magnet wheel.

In this case, provision may also be made that during the shrinking-on process, a force-fitting connection is formed between individual permanent magnets which in each case rest on one another, and/or between magnet segments which in each case rest on one another and comprise a plurality of individual permanent magnets, and/or between laminate or metal segments which in each case rest on one another and form the support.

Furthermore, one expedient development of the invention provides that an anaerobically curing adhesive (15) is used. Since the joint between the pole wheel housing and the magnet system becomes negligibly small as a result of the pole wheel housing cooling down during the shrinking process, with oxygen thus being extracted from the adhesive, it is possible to create a high-strength connection in the joint between the magnet ring or magnet wheel and the pole wheel housing just while the pole wheel housing is cooling down.

In order to be flexible with regard to the material of the pole wheel housing, such that this need not be composed of metal or need not have a metal internal surface, a further refinement of the invention provides that before wetting with the anaerobically curing adhesive, an activator is applied to the external circumferential surface of the at least one magnet ring or of the magnet wheel, and/or to the retaining surface. It is therefore possible for the pole wheel housing to also be composed of a material which is passive for the anaerobically curing adhesive and has no catalytic effect.

A further refinement of the invention provides that before the arrangement of the at least one magnet ring or of the magnet wheel, its external circumferential surface and/or the retaining surface are/is roughened by means of sandblasting or shotblasting. This improves the adhesion of the adhesive, and makes it possible to increase the load capability of the connection which is subsequently formed.

For financial reasons, it is advantageous with regard to providing a cost-effective method if the adhesive which emerges from the connecting joint which is formed between the at least one magnet ring or the magnet wheel and the pole wheel housing is sucked out and reused, as the invention, finally, also provides.

In a refinement of the magnet system, the invention is distinguished in that the at least one magnet ring or the magnet wheel has a force-fitting connection between individual permanent magnets which each rest on one another and/or between magnet segments which each rest on one another and comprise a plurality of individual permanent magnets, and/or between laminate or metal segments which each rest on one another and form the support.

It is self-evident that the features mentioned above and those which are still to be explained in the following text can be used not only in the respectively stated. combination but also in other combinations. The scope of the invention is defined only by the claims.

Further details, features and advantages of the subject matter of the invention will become evident from the following description, in conjunction with the drawing in which, by way of example, one preferred exemplary embodiment of the invention is illustrated, and in which:

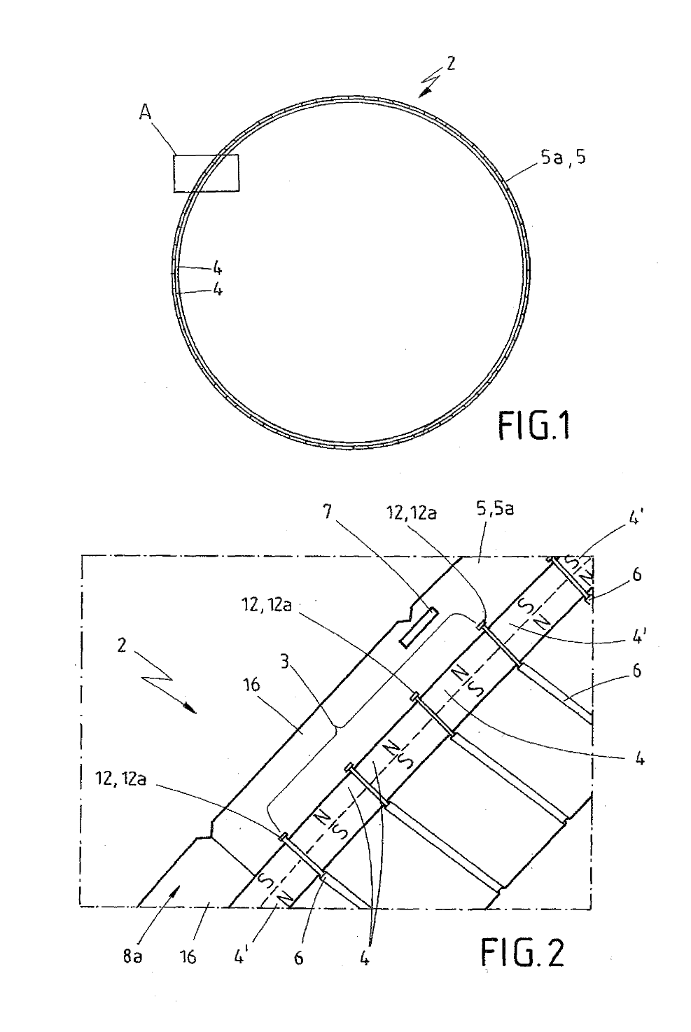

FIG. 1 shows a schematic illustration, in the form of a plan view, of a magnet ring,

FIG. 2 shows an enlarged illustration of the detail A from FIG. 1,

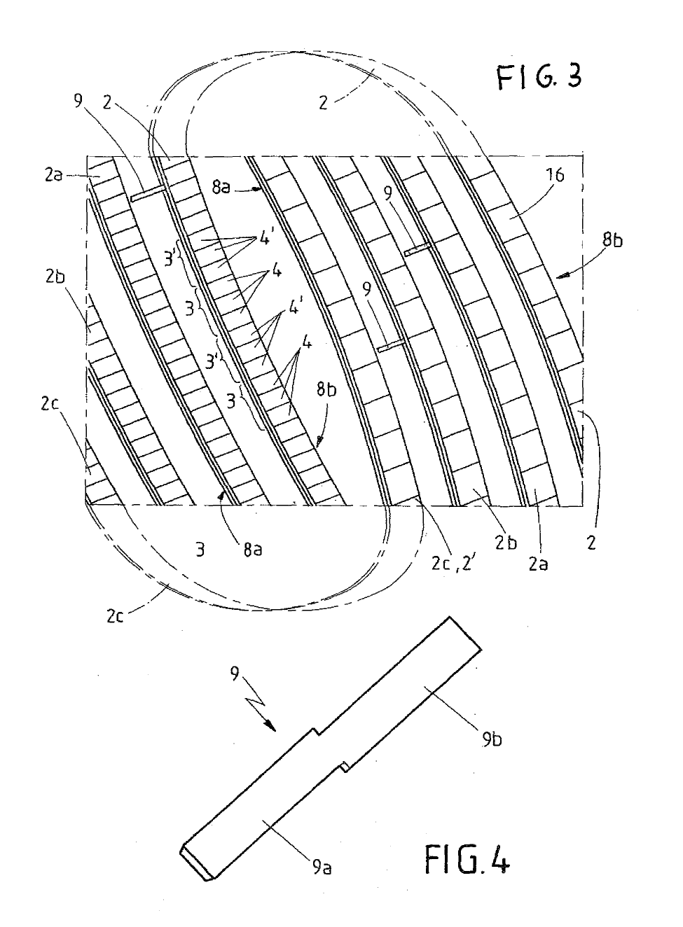

FIG. 3 shows a perspective, schematic illustration of a plurality of magnet rings before assembly to form a magnet wheel,

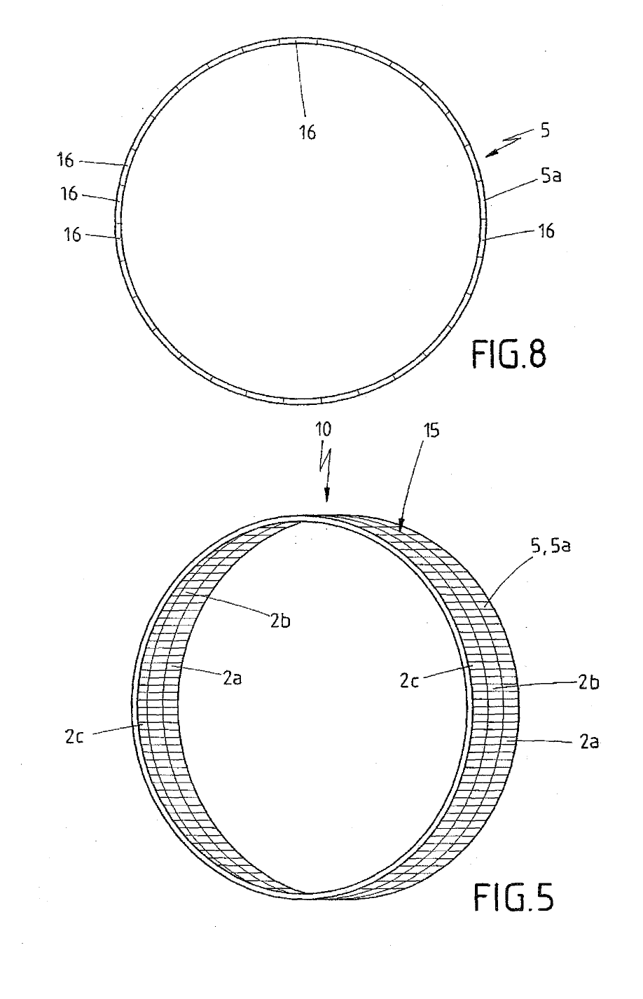

FIG. 4 shows a schematic illustration of a guide element,

FIG. 5 shows a schematic perspective illustration of a magnet wheel composed of a plurality of magnet rings,

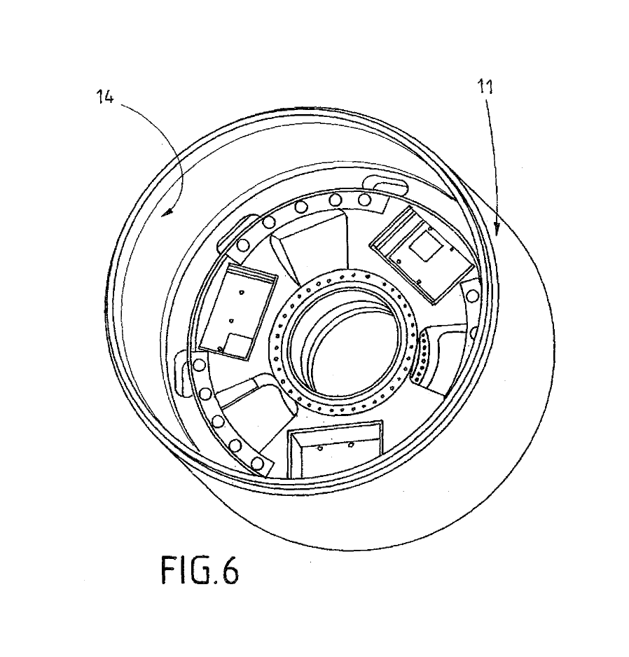

FIG. 6 shows a pole wheel housing with a retaining surface for a magnet wheel,

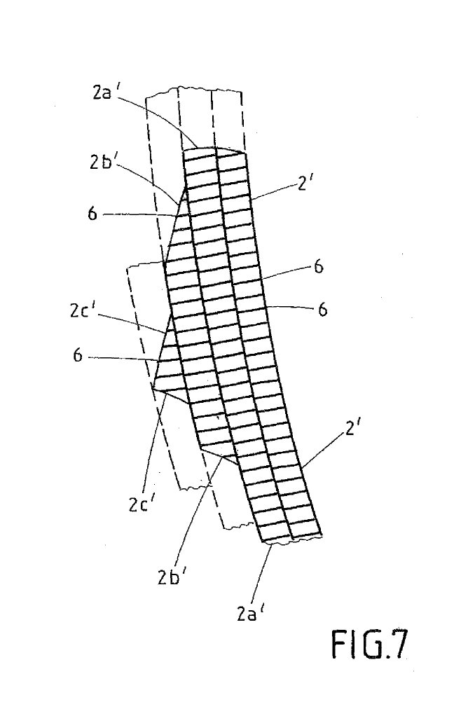

FIG. 7 shows an alternative embodiment of a magnet arrangement, in the form of a partial view, and

FIG. 8 shows a magnetic return-path ring.

A wind energy installation or wind power installation essentially comprises a rotor with a hub and rotor blades and a machine pod, which surrounds the generator. By way of example, the mechanical power which is produced by means of the rotor blades is converted to electrical power by means of a multipole generator, preferably a synchronous generator, which is operated at the same rotation speed as the rotor and is accommodated in the machine pod. A multipole generator such as this has a stator with windings and a rotor which surrounds the stator (external rotor) or a rotor which is surrounded by the stator (internal rotor).

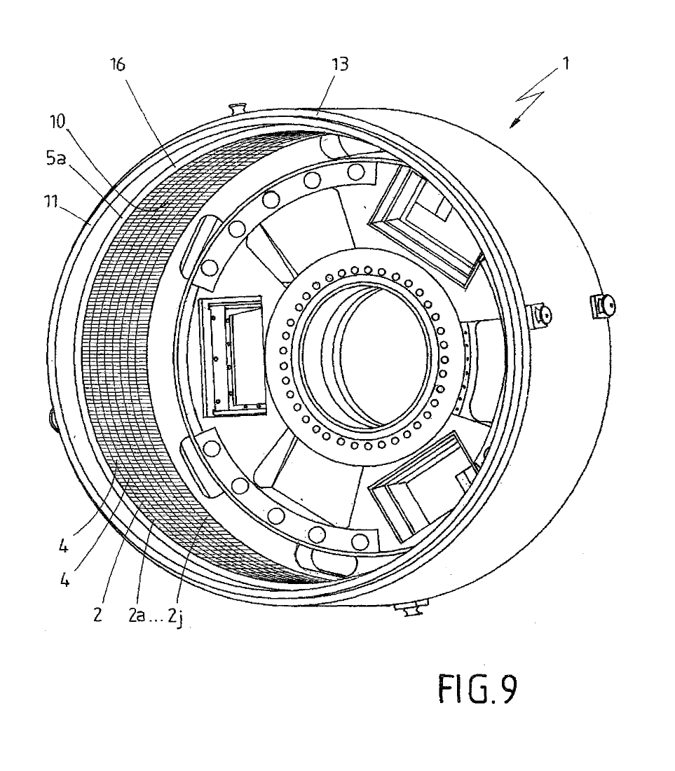

The exemplary embodiment represents an external rotor which forms a magnet system 1, which is illustrated in FIG. 9 and comprises a plurality of magnet rings 2, 2a-2j, 2′, 2a′, 2b′, 2c′ which are assembled to form a magnet wheel 10 which is installed in a pole wheel housing 11, on the inside, on a retaining surface 14.

Each magnet ring 2, 2a-2j, 2′, 2a′, 2b′, 2c′ has a multiplicity of individual permanent magnets 4, 4′ which are arranged around the circumference of the respective magnet ring, with three individual permanent magnets 4, 4′, which are arranged alongside one another and are aligned with the same polarity, in each case forming a magnet segment 3, 3′. The magnet segments 3, 3′ are themselves arranged alongside one another with alternating polarity alignment, as can be seen in FIG. 2. In this case, the south pole S and the north pole N are each aligned in the radial direction, as a result of which a magnet segment 3 with an external north-pole area and an internal south-pole area and a magnet segment 3′ with an external south-pole area and an internal north-pole area in each case follow one another alternately in the circumferential direction. Each magnet segment 3, 3′ itself comprises a plurality of individual permanent magnets 4, 4′ which are arranged alongside one another on the longitudinal side, in each case aligned with the same polarity, in order to reduce the eddy-current losses which would otherwise be very high with large pole areas. In the exemplary embodiment, a magnet segment 3, 3′ is in each case composed of three individual permanent magnets 4, 4′. However, magnet segments 3, 3′ with a different number of individual permanent magnets 4, 4′ to this are also feasible. The individual permanent magnets 4, 4′ are produced from a metal from the rare earths, in particular from a high-permeability, sintered metal powder using these metals.

The gaps between each of the adjacent individual permanent magnets 4, 4′ are kept as small as possible in order to optimize the performance of a generator which has an external rotor with a magnet wheel 10. For this purpose, the individual permanent magnets 4, 4′ are inserted on the inside into a support 5 which forms a magnetic return-path ring 5a, with the magnetic return-path ring 5a that has been equipped with the individual permanent magnets 4, 4′ then in each case forming a magnet ring 2, 2′, 2a′-2c′, 2a-2j.

The magnetic return-path ring 5a is composed of individual metal segments 16 which, resting on one another, form the magnetic return-path ring 5a which is in the form of a circular ring. The individual metal segments 16 can be connected to one another via connecting lugs, and can be welded to one another. In particular, they are pressed together with a force fit when the magnetic return-path ring 5a is inserted with the individual permanent magnets 4, 4′ inserted in it into the pole wheel housing 11, and is then pressed together along the retaining surface 14 as the heated pole wheel housing 11 cools down, as will be explained in the following text.

In order to allow the individual permanent magnets 4, 4′ to be arranged at as short a distance from one another as possible on the magnetic return-path ring 5a during assembly, the magnetic return-path ring 5a is provided with retaining elements 12 in the form of slots 12a, which are in the form of grooves, run in the axial direction and are distributed uniformly over its internal circumferential surface, at a distance corresponding to the width of an individual permanent magnet 4, 4′. A holding element 6 which has a double-T-shaped cross section and acts as a bracket is inserted into each of these slots 12a which are in the form of grooves. One individual permanent magnet 4, 4′ is then arranged between each two holding elements 6 and is fixed by the holding elements 6 on the inside of the magnetic return-path ring 5a. In this case, the holding elements 6 have a very small thickness extent, as a result of which there is only an extremely narrow gap between mutually adjacent individual permanent magnets 4, 4′. The magnetic return-path ring 5a is of such a strength or thickness that it is no longer possible to detect any magnetic force on its outside when individual permanent magnets 4, 4′ are fitted on its inside and, in consequence, there is no externally acting magnetic force. A steel material with as high a component of iron as possible and a small component of alloying elements is preferably used to produce the magnetic return-path ring 5a or the metal segments 16.

As is indicated by the holding elements 6 inserted therein in FIG. 7, the retaining elements 12 can easily be aligned inclined obliquely with a gradient of 6°-20°. The retaining elements 12 may also be in the form of rails.

The dimensions of the magnetic return-path ring 5a, the magnet segments 3, 3′ and the individual permanent magnets 4, 4′ are matched to one another such that they result in an even number of magnet segments 3, 3′ distributed uniformly around the internal circumference of the magnetic return-path ring 5a, with magnet segments 3, 3′ with the same or identically aligned polarity then in each case being diametrically opposite. The assembly procedure is now carried out such that the magnet segments 3 with the same polarity alignment are first of all arranged on the inside on the magnetic return-path ring 5a between the individual holding elements 6, and only then are the magnet segments 3′ with the polarity aligned in the opposite direction inserted into the intermediate spaces which then exist. During this process, the holding elements 6 form separating walls and guide rails between individual permanent magnets 4, 4′ which in each case rest on one another, in such a way that, both in the case of a repelling polarity arranged in the same direction and in the case of an attracting polarity, a respective individual permanent magnet 4, 4′ can be reliably inserted, guided between two holding elements 6, in the axial direction of the magnetic return-path ring 5a into its respectively intended position.

The magnetic return-path ring 5a is designed with thin walls and is composed of individual laminate segments 16.

A plurality of the magnet rings 2, 2′, 2a-2j, 2a′, 2b′, 2c′ which each comprise a magnetic return-path ring 5a with individual permanent magnets 4, 4′ inserted in them are assembled to form a magnet wheel 10, corresponding to the respectively desired and intended power of the generator or the pole wheel that is equipped in this way. For this purpose, the individual magnet rings 2, 2′, 2a′-2c′, 2a-2j are placed on one another at the sides, piece by piece, in the axial direction of the magnet wheel 10 until the desired number of magnet rings have been formed. In the case of the pole wheel housing 11 which is illustrated in FIG. 9 and is equipped with a magnet wheel 10, 11 magnet rings 2-2j are arranged in a row in order to form the magnet wheel 10. When the individual magnet rings are in the assembled position to form the magnet wheel 10, magnet segments 3, 3′ of the same polarity and therefore repelling poles of the individual permanent magnets 4, 4′ in this case rest on one another, at least in places, in the axial direction of the magnet wheel 10. The magnet segments 3, 3′ which rest on one another with the same polarity of mutually adjacent magnet rings 2, 2′, 2a-2j, 2a′-2c′ therefore result in a repulsion force effect in the axial direction during the assembly of the magnet wheel 10, that is to say in the direction parallel to the magnet ring axis or magnet wheel axis. In this case, and additionally, because of the magnetic forces of the magnet segments 3, 3′ with the same polarity or the same polarity alignment, the magnet rings which in each case rest on one another attempt to align themselves in a stable north-south position, that is to say to rotate so far relative to one another that attracting magnet segments 3, 3′ with an opposite polarity alignment in each case rest on one another. In order to ensure that this is not possible, the magnet rings 2, 2′, 2a′-2c′, 2a-2j must be guided while they are being assembled to form a magnet wheel 10, and must be held in their relative position with respect to one another. For this purpose a plurality of guide holes 7 are formed uniformly along the circumference in each of the two side surfaces 8a, 8b in each magnetic return-path ring 5a of a respective magnet ring. The guide holes 7 may be formed either at regular or at irregular angular intervals along the circumference in the respective side surface 8a, 8b. The only important factor is that the guide holes 7 which are formed in magnet rings 2 which are arranged adjacent to one another in the installed state are aligned or can be aligned in the assembled position of the respective magnet rings to correspond to one another, that is to say aligned or with an offset with respect to one another which is bridged by a guide element 9. During assembly of the magnet wheel 10, the first guide section 9a of a guide element 9 which is in the form of a rod or bar is in each case inserted into a respective guide hole 7, which may also be a blind hole. A second guide section 9b of the guide element 9 then projects out of this guide hole 7 in the magnet ring 2 and is used to guide a further magnet ring, which can be stacked on the respective magnet ring. For this purpose, the second guide section 9b is inserted into a guide hole 7, which corresponds to the guide hole 7, in the magnet ring to be stacked on it, for example the magnet ring 2a, such that the magnet ring 2a to be stacked oh it can be pressed against the magnet ring 2 in an aligned position, without any mutual rotation occurring between the two magnet rings 2, 2a as a result of the magnetic forces that act. Mutually adjacent magnet rings, for example the magnet rings 2 and 2a, can therefore be formed in layers on one another and can be aligned with respect to one another by means of the guide elements 9.

In this case, the mutually adjacent magnet rings 2, 2′, 2a′-2c′, 2a-2j are attached to the corresponding side surfaces 8a, 8b by means of an integral joint, with these side surfaces 8a, 8b comprising the side surfaces of the magnetic return-path ring 5a and of the individual permanent magnets 4, 4′. For this purpose, and before the individual magnet rings are stacked, at least one of the mutually adjacent side surfaces 8a or 8b of a magnet ring is coated with an anaerobically curing adhesive, which forms the integral joint to the magnet ring 2, 2′ adjacent to it. The adhesive is an anaerobically curing adhesive in the form of a single-component adhesive, which cures with oxygen being excluded. The curer component contained in the adhesive remains inactive as long as it is in contact with the oxygen in the air. As soon as the adhesive is separated from the oxygen, as is the case when two magnet rings are stacked one on top of the other and their side surfaces 8a, 8b which rest on one another are then pressed onto one another, the curing process takes place very quickly, in particular when there is metal contact at the same time. Even the very small intermediate spaces in the joint area are filled by the capillary effect of the liquid adhesive. The cured adhesive is then anchored in the depressions in the roughness of those side surfaces 8a, 8b of the mutually adjacent magnet rings which are to be connected. The curing process is initiated by the contact of the adhesive with the metal surfaces of the two side surfaces 8a, 8b of the mutually adjacent metal rings, such that the metal surfaces then act as a catalyst.

For the situation in which the side surfaces 8a, 8b of the magnet rings are composed of a non-metallic material, that is to say a material which is passive for the adhesive bonding process, an activator can be applied, before the coating process with the anaerobically curing adhesive, to at least one of the two side surfaces 8a, 8b, which are arranged adjacent to one another, of the magnet rings to be connected to one another. The application of an activator is recommended because passive materials such as these have only a minor catalytic effect, or none at all, as is necessary for curing of the anaerobic adhesive. Use of an activator is also recommended in order to avoid lack of correct adhesion when using metals with high passive characteristics, such as chromium and stainless steel. Adhesive bonding of this type additionally seals the connection point against corrosive media. Furthermore, an anaerobically curing adhesive such as this has good resistance to mechanical vibration, and good resistance to dynamic fatigue loads.

The use of an anaerobically curing adhesive with or without an activator ensures that the curing process in the joint between the respective magnet rings starts only after contact between two magnet rings.

In the case of the exemplary embodiment described above, the guide holes 7 which are formed in the side surfaces 8a, 8b of a respective magnet ring 2, 2′, 2a-2j, 2a′-2c′ are formed at the same circumferential position, on all the magnet rings, with respect to the magnet segments 3, 3′ which are arranged around the circumference of a magnet ring. This then results in a magnet wheel 10 which is formed from layers or a stack of a plurality of magnet rings, with magnet segments 3, 3′ which are arranged parallel to the magnet ring axis or magnet wheel axis or magnet system axis, with magnet segments of the same polarity alignment being arranged in a row in a line. In consequence, the holding elements 6 form a line which runs straight and parallel to the magnet wheel longitudinal axis from one individual permanent magnet 4, 4′ to another individual permanent magnet 4, 4′ of magnet rings which rest on one another, as is illustrated in FIG. 9 for a magnet wheel 10, which comprises 11 magnet rings 2-2j, for the magnet system 1.

In order to provide a magnet wheel system 10 with three-dimensionally curved magnet segments 3, 3′ which run obliquely with respect to the magnet wheel axis, as is illustrated schematically in FIG. 7, a second exemplary embodiment provides that the second guide section 9b is formed laterally offset with respect to the first guide section 9a of the respective guide element 9 in the circumferential direction of the respective magnet rings. FIG. 4 illustrates one such guide element 9. In this case, the offset between the first guide section 9a and the second guide section 9b of the guide element 9 is designed such that, when a magnet wheel 10 is in the assembled position, the magnet segments 3, 3′ and/or the individual permanent magnets 4, 4′ on the individual magnet rings are each arranged offset with respect to one another from one magnet ring to another magnet ring in the axial direction, in the direction of the magnet ring axis. In this case, the offset between the first guide section 9a and the second guide section 9b of the respective guide element 9 can be designed such that, when the magnet wheel 10 is in the assembled position, the magnet segments 3, 3′ which are associated with one another and have the same polarity alignment of the individual magnet rings are arranged offset in the form of a staircase in the axial direction with respect to the magnet ring axis. Whether the separating line which is formed between the individual permanent magnets 4, 4′ by the holding elements 6 runs parallel or inclined, in particular at an angle of 6°-20° with respect to the magnet wheel axis or magnet ring axis, is in this case governed by the alignment of the retaining elements 12, which governs this. The offset between the first guide section 9a and the second guide section 9b of the guide element 9 in the circumferential direction of the magnet rings may in this case be considerably smaller than a circle section of one respective magnet segment 3. Alternatively, however, it is also possible for the slots 12 which are in the form of grooves to be inclined obliquely and for a correspondingly obliquely aligned arrangement of the individual permanent magnets 4, 4′ to be produced by appropriate geometric configuration of the individual permanent magnets 4, 4′.

A magnet wheel 10 having three-dimensionally curved side edges/side surfaces, which run obliquely with respect to the magnet system axis, of the magnet segments 3, 3′ may also be provided with a guide element 9 in the form of a rod, without offset first and second guide sections 9a, 9b, in which guide element 9, according to a further exemplary embodiment, the guide holes 7, which are formed in mutually associated side surfaces 8a, 8b of a respective magnet ring, are offset with respect to the magnet segments 3 which are in each case arranged around the circumference of the magnet rings, that is to say have a different relative position with respect to the retaining elements 12 on each of the two side surfaces 8a, 8b. The offset between the guide holes 7 in the mutually facing side surfaces 8a, 8b of adjacent magnet rings can once again be designed such that when the magnet wheel 10 is in the assembled position, the magnet segments 3, 3′ with the same polarity alignment from one magnet ring to another magnet ring are arranged such that they run essentially obliquely at an angle of 6° to 20° with respect to the magnet ring axis in the axial direction. However, alternatively, it is also once again feasible for the offset between the guide holes 7 of respectively adjacent magnet rings to be designed such that, when the magnet wheel 10 is in the assembled position, the magnet segments 3, 3′ with the same polarity alignment from one magnet ring to another magnet ring are arranged offset in the form of a staircase with respect to the magnet ring axis in the axial direction. The offset between the guide holes 7 of adjacent magnet rings in the circumferential direction of the magnet rings may be considerably less than a circle section of a respective magnet segment.

Therefore, overall, there are various design options for the alignment of the individual permanent magnets 4, 4′ and of the magnet segments 3, 3′ both in each case in a single magnet ring and in their alignment from one magnet ring to another magnet ring, for magnet rings which are assembled to form a magnet wheel 10. In order to align the individual permanent magnets 4, 4′ on the respective support 5 at right angles to the side edge of the annular support 5 or parallel to the magnet ring axis, it is possible to appropriately align the retaining elements 12 and therefore the holding elements 6 which are held and guided therein. Rectangular, cuboid individual permanent magnets 4, 4′ can then be inserted from the side between two holding elements 6. If the intention is to arrange individual magnet segments 4, 4′ which are arranged obliquely inclined on a support 5, then this can be done by forming and arranging the retaining elements 12 of the support 5, and in consequence the holding elements 6 which are arranged therein or thereon, with a corresponding inclination of 6°-20° with respect to the magnet ring axis or magnet wheel axis which runs through the magnet ring centre point. A cuboid, which is in the form of a parallelogram when seen in a plan view, of an individual permanent magnet 4, 4′ can then be arranged between two holding elements 6. In the case of magnet rings which rest on one another, the relative position of the individual permanent magnets 4, 4′ with respect to one another from one magnet ring to another magnet ring can be fixed in a variable form by the corresponding embodiment of the guide holes 7 in the respective side surfaces 8a, 8b and the configuration of the guide elements 9. It is therefore possible for the individual permanent magnets 4, 4′ to each be arranged offset with respect to one another from one magnet ring to another magnet ring, and for the holding elements 6 likewise to have a stepped offset from one magnet ring to another magnet ring. However, it is also possible to arrange the individual magnet segments 4, 4′ in a linear form in a row with respect to one another, such that the holding elements 6 which have been arranged in a row then form a continuous line in the magnet wheel 10, which is inclined obliquely, aligned at an angle of 6°-20° or else in a straight line, that is to say parallel to the magnet wheel axis which runs through the magnet wheel centre point.

In order to increase the magnetic pole sensitivity, which results in conjunction with a slotted armature of a machine, a laminated armature core must be laminated such that the slots run obliquely with respect to the centre axis. This makes it more difficult to use windings composed of rectangular coils, which are required to maximize the utilization of the machine. In order to allow a non-skewed armature to be used, however, the magnet system 1 or a magnet wheel 10 must be inclined, which is impossible when using simple rectangular magnet segments 3, 3′. However, the same effect can be achieved by using guide elements with discontinuities or steps, or those with offset guide sections 9a, 9b, instead of straight guide elements 9, as is illustrated in FIG. 4. This results in a magnet system 1 with magnet rings 2′, 2a′-2c′ which are offset in the form of a staircase, which is electrically equivalent to skewing, and is illustrated schematically in FIG. 7.

Overall, the invention provides a magnet system 1, which comprises a pole wheel 13, of an external rotor type, which comprises a magnet wheel 10 which is formed from individual magnet rings 2, 2′, 2a, 2b, 2c, 2d, 2e, 2f, 2g, 2h, 2i, 2j, 2a′-2c′ with a plurality of magnetized magnet segments 3, 3′ of alternating polarity, which can be used for a generator in a wind energy installation.

Although the described magnet system may have similarities to apparatuses which are known per se, it is particularly significant here that a magnet system such as this is also used in the field of highly loaded components of wind energy installations, and can be used successfully in this case.

The magnet system 1, which comprises the pole wheel housing 11 with the magnet wheel 10 inserted in it, therefore comprises individual magnet rings, which may be electrically insulated from one another as a result of the connection by means of an adhesive, and which are stacked corresponding to the axial overall length of the magnet wheel 10 to form a core, and form a thin-walled magnetic return-path ring 5a for guidance of the magnetic lines of force and for external screening. The core is also provided with its mechanical strength by means of holders or struts or guide elements 9, which are preferably welded-in in magnetically unloaded zones.

The annular magnet wheel 10, which comprises a plurality of magnet rings, is connected during production of the pole wheel 13 to the pole wheel housing 11, which is illustrated in FIG. 6, with the magnet wheel 10 being fitted internally in the pole wheel housing 11. In order to save weight, the pole wheel housing 11 may be composed of a non-magnetic material. A retaining surface 14 is formed in the internal circumference of the pole wheel housing 11. The retaining surface 14 may, for example, be a minimal depression or indentation, which is matched to the geometric dimensions of the magnet wheel 10, in order to form a connection to the pole wheel housing 11.

In order to produce the pole wheel, the pole wheel housing 11 is heated slightly, in a first step, in order to allow the pole wheel housing 11 and the magnet wheel 10 to be joined. The pole wheel housing 11. is heated to a temperature at which the internal diameter of the pole wheel housing 11, in particular the diameter of the retaining surface 14, expands to a diameter which is greater than the external diameter of the magnet wheel 10.

In a step which follows the heating of the pole wheel housing 11, the magnet wheel 10 is then arranged in or on the retaining surface 14 which is formed in the internal circumferential surface of the pole wheel housing 11.

In a step which follows this, the pole wheel housing 11 is cooled down, or the pole wheel housing is allowed to cool down such that the pole wheel housing 11 is shrunk onto the magnet wheel 10. The shrinking process is therefore based on the principle of thermal expansion, in which the two parts to be connected to one another are not manufactured with an accurate fit, but the pole wheel housing 11 is manufactured to be slightly too small or the magnet wheel 10 to be slightly too large, which means that the two parts cannot be connected to one another at a normal temperature, that is to say in general at room temperature or ambient temperature. The respectively heated item expands by heating, and then shrinks again when it cools down. As it cools down, the pole wheel housing 11 therefore shrinks, and is pressed onto the magnet wheel 10. By way of example, the pole wheel housing 11 can be cooled down in an ambient temperature environment.

In one step of the method, the external circumferential surface of the magnet wheel 10, that is to say the outside of the magnetic return-path ring 5a, is coated with an adhesive 15. Alternatively, however, the retaining surface 14 of the pole wheel housing 11 can also be coated with an adhesive. It is furthermore also feasible for both the external circumferential surface of the magnet wheel 10 and the retaining surface 4 of the pole wheel housing 11 to be coated with an adhesive. The coating of the external circumferential surface of the magnet wheel 10 or of the retaining surface 4 of the pole wheel housing 11, or of both surfaces jointly, can in this case be carried out at very different times while carrying out the joining process to connect these two components. For example, the coating can be carried out before the heating of the pole wheel housing 11, before the arrangement of the magnet wheel 10, or before the pole wheel housing 11 has been cooled down.

The adhesive which is used during the coating process is likewise an anaerobically curing adhesive in the form of a single-component adhesive, which cures at room temperature, with oxygen being excluded. The curer component which is contained in the liquid adhesive remains inactive as long as it is in contact with the oxygen in the air. As soon as the adhesive 15 is excluded from oxygen, as is the case during the process of joining or shrinking the pole wheel housing 11 onto the magnet wheel 10, the curing process takes place very quickly, in particular with metal contact at the same time. Even very small intermediate spaces in the joint area are filled by the capillary effect of the liquid adhesive 15. The cured adhesive is then anchored in the depressions in the roughness of the parts to be connected. The curing process is initiated by the contact of the adhesive 15 with the metal surfaces of the pole wheel housing 11 and the magnet wheel 10, as a result of which these metal surfaces accordingly act as a catalyst. Metallic materials can thus be adhesively bonded to one another.

For the situation in which the pole wheel housing 11 is composed of a non-metallic material, that is to say a material which is initially passive for the adhesive bonding process, an activator can be applied to the retaining surface 14 of the pole wheel housing 11 before coating with the anaerobically curing adhesive 15. If the external circumferential surface of the magnet wheel 10 has a layer of non-metallic material, then this surface can also be coated with an activator. The application of an activator is recommended because passive materials have only a slight catalytic effect, or no catalytic effect at all, and this is required for curing of the anaerobic adhesive. The use of an activator is also recommended, in order to avoid incorrect adhesive joints, in the case of metals with high passive characteristics, such as chromium and stainless steel. An adhesive joint of this type additionally seals the connecting point of the pole wheel housing 11 and the magnet wheel 10 against corrosive media. Furthermore, an anaerobically curing adhesive 15 such as this has good resistance to mechanical vibration, and good resistance to dynamic fatigue loads.

Irrespective of whether or not an activator is used, the method may have an additional step, in which, before the arrangement of the magnet wheel 10, the external circumferential surface of the magnet wheel 10, that is to say the external surface of the magnetic return-path ring 5a, or the retaining surface 14 of the pole wheel housing 11, is roughened by means of sandblasting or shotblasting. However, it is also feasible for both surfaces to be roughened by means of sandblasting or shotblasting. This measure improves the adhesion of the adhesive 15 and the load capability of the joint which is formed between the pole wheel housing 11 and the metal wheel formed from magnetic return-path rings 5a.

In consequence, the method described above combines an adhesive process and a pressing process as the pole wheel housing 11 cools down, which jointly and simultaneously produce their effect, in order to create the connection between the pole wheel housing 11 and the magnet wheel 10. As the pole wheel housing 11 cools down, it surrounds the magnet wheel 10 with slight pressure in the form of a force fit, with the adhesive connection resulting in an integral joint. In this case, a retaining surface 14, which is in a recessed form with a side edge, can also contribute interlocking components. In any case, this prevents the adhesive 15 which is located between the external circumferential surface of the magnet wheel 10 and the retaining surface 14 of the pole wheel housing 11 from having any contact with oxygen, as a result of which it can cure, resulting in a high-strength connection, in the form of an integral joint. The cooling down of the pole wheel housing 11 and the surrounding of the magnet wheel 10 linked to this result in the individual permanent magnets 4, 4′ and the individual magnet segments 3, 3′ of the magnet wheel 10 being pressed against one another and/or against the holding elements 6. The individual metal segments 16 of the support 5 are likewise forced or pressed against one another. All these elements may therefore additionally form a joint between themselves, in the form of a force fit. When the pole wheel housing 11 cools down and is shrunk onto the magnet wheel 10, this therefore produces an integral connection between the pole wheel housing 11 and the magnet wheel 10, and an at least force-fitting connection between the individual magnet segments 3, 3′ or the individual permanent magnets 4, 4′ of the magnet wheel 10, or between these elements and the respective holding elements 6 resting thereon, thus, together with the pole wheel housing 11, forming the magnet system 1.

In order to avoid using excessive adhesive 15, for financial reasons, it is recommended that the adhesive which emerges from the connecting joint formed between the magnet wheel 10 and the pole wheel housing 11 be sucked out and reused.

Therefore, overall, this provides a method for production of a pole wheel 13 of the external rotor type by means of a “shrink-adhesion joint”, which has integral and force-fitting connections between the pole wheel housing 11 and the magnet wheel 10, and between the individual magnet segments 3, 3′ and/or the individual permanent magnets 4, 4′ and the holding elements 6 of the magnet wheel 10. The “shrink-adhesion joint” results in a considerable improvement with respect to any shear forces and bending moments that occur, with the connected components being connected to one another over the entire length such that it is virtually impossible to detach them.

A pole wheel 13 of the external rotor type produced using this method and having a magnet wheel 10 with a plurality of magnetized magnet segments 3, 3′ of alternating polarity alignment and having a pole wheel housing 11 can be used for a generator for a wind energy installation.

Although the described method may have similarities with methods which are known per se, it is particularly important here that a method such as this for production of an adhesive joint and shrink joint can also be used in the field of highly loaded components of wind energy installations, and can be used successfully in this case.

1. Method for production of a magnet system, which comprises a pole wheel, of a multipole generator for a wind power installation or wind energy installation, comprising
the connection of a pole wheel housing to at least one magnet ring, which has a multiplicity of individual permanent magnets arranged in the form of a circular ring, or to a magnet wheel which has at least one magnet ring and a support supporting it, by heating of the pole wheel housing to a temperature at which the internal diameter of an internal circumferential surface, which forms a retaining surface, of the pole wheel housing expands to a size which is larger than the external diameter of the magnet ring or of the magnet wheel,
the arrangement of the at least one magnet ring or of the magnet wheel in or on the retaining surface, and
the shrinking of the pole wheel housing onto the at least one magnet ring or the magnet wheel by cooling down the pole wheel housing to room temperature or ambient temperature, wherein before the heating of the pole wheel housing or before the arrangement of the magnet ring or of the magnet wheel, and/or before the cooling down of the pole wheel housing, the external circumferential surface of the at least one magnet ring or magnet wheel and/or the retaining surface is provided with an adhesive such that an integral connection is formed between the pole wheel housing and the at least one magnet ring or magnet wheel from the adhesive, while the pole wheel housing is being shrunk on.

2. Method according to claim 1, wherein, during the shrinking-on process, a force-fitting connection is formed between individual permanent magnets which in each case rest on one another, and/or between magnet segments which in each case rest on one another and comprise a plurality of individual permanent magnets, and/or between laminate or metal segments which in each case rest on one another and form the support.

3. Method according to claim 1, wherein an anaerobically curing adhesive is used.

4. Method according to claim 1, wherein, before wetting with the anaerobically curing adhesive, an activator is applied to the external circumferential surface of the at least one magnet ring or of the magnet wheel, and/or to the retaining surface.

5. Method according to claim 1, wherein, before the arrangement of the at least one magnet ring or of the magnet wheel, its external circumferential surface and/or the retaining surface are/is roughened by means of sandblasting or shotblasting.

6. Method according claim 1, wherein the adhesive which emerges from the connecting joint which is formed between the at least one magnet ring or the magnet wheel and the pole wheel housing is sucked out and reused.

7. Magnet system of a multipole generator of a wind power installation or of a wind energy installation, comprising a pole wheel which has a pole wheel housing and has at least one magnet ring, which is arranged in the pole wheel housing and is formed from a support with individual permanent magnets arranged on it, and/or has a magnet wheel which has a magnet ring such as this, wherein the pole wheel has an integral connection between its pole wheel housing and the at least one magnet ring or the magnet wheel, with the magnet system being produced by means of a method according to claim 1.

8. Magnet system according to claim 7, wherein the at least one magnet ring or the magnet wheel has a force-fitting connection between individual permanent magnets which each rest on one another and/or between magnet segments which each rest on one another and comprise a plurality of individual permanent magnets, and/or between laminate or metal segments which each rest on one another and form the support.
